(19) United States
(12) Patent Application Publication
(10) Pub. No.: US 2022/0058824 A1
(43) Pub. Date: Feb. 24, 2022

(54) METHOD AND APPARATUS FOR IMAGE LABELING, ELECTRONIC DEVICE, STORAGE MEDIUM, AND COMPUTER PROGRAM

(71) Applicant: SHANGHAI SENSETIME INTELLIGENT TECHNOLOGY CO., LTD., Shanghai (CN)

(72) Inventors: Kunlin YANG, Shanghai (CN); Pengcheng XIA, Shanghai (CN); Jun HOU, Shanghai (CN); Shuai YI, Shanghai (CN)

(73) Assignee: SHANGHAI SENSETIME INTELLIGENT TECHNOLOGY CO., LTD., Shanghai (CN)

(21) Appl. No.: 17/453,834

(22) Filed: Nov. 5, 2021

Related U.S. Application Data
(63) Continuation of application No. PCT/CN2020/135498, filed on Dec. 10, 2020.

(30) Foreign Application Priority Data
May 28, 2020 (CN) 202010470248.X

(51) Int. Cl. G06T 7/73; G06K 9/46; G06T 3/40; G06K 9/62; G06T 7/62; G06F 16/58

(52) U.S. Cl. CPC G06T 7/73; G06K 9/46; G06T 3/4046; G06K 9/629; G06K 9/6215; G06T 2207/20081; G06K 9/6256; G06F 16/5866; G06T 2207/20084; G06T 2207/30196; G06T 7/62

(57) ABSTRACT

A method for image labeling can include the following operations. An image to be labeled and a first scale indicator are acquired. A pixel neighborhood is constructed based on the first person point under the condition that the first scale indicator is more than or equal to a first threshold, the pixel neighborhood including a second pixel different from the first person point. A position of the second pixel is determined as the person point tag of the first person.

### CROSS-REFERENCE TO RELATED APPLICATIONS

This is a continuation of International Application No. PCT/CN2020/135498 filed on Dec. 10, 2020, which claims priority to Chinese Patent Application No. 202010470248.X filed on May 28, 2020. The disclosures of these applications are hereby incorporated by reference in their entirety.

### BACKGROUND

With the rapid development of a computer vision technology, various computer vision models have emerged, including a person positioning model. Before the person positioning model is used for positioning, the person positioning model is required to be trained. Labeling information of a training image is a position of a pixel in a person region in the training image.

### SUMMARY

The disclosure relates to the technical field of computer vision, and particularly to a method and apparatus for image labeling, an electronic device, a storage medium, and a computer program.

Embodiments of the disclosure provide a method and apparatus for image labeling, an electronic device, a storage medium, and a computer program.

A first aspect provides a method for image labeling, which may include the following operations. An image to be labeled and a first scale indicator are acquired. Herein, the image to be labeled may contain a person point tag of a first person, the person point tag of the first person may include a first position of a first person point, the first scale indicator may represent a mapping between a first size and a second size, the first size may be a size of a first reference object at the first position, and the second size may be a size of the first reference object in a real world. A pixel neighborhood is constructed based on the first person point under the condition that the first scale indicator is more than or equal to a first threshold, the pixel neighborhood including a first pixel different from the first person point. A position of the first pixel is determined as the person point tag of the first person.

A second aspect provides an apparatus for image labeling, which may include an acquisition unit, a construction unit, and a first processing unit.

The acquisition unit may be configured to acquire an image to be labeled and a first scale indicator. Herein, the image to be labeled may contain a person point tag of a first person, the person point tag of the first person may include a first position of a first person point, the first scale indicator may represent a mapping between a first size and a second size, the first size may be a size of a first reference object at the first position, and the second size may be a size of the first reference object in a real world.

The construction unit may be configured to construct a pixel neighborhood based on the first person point under the condition that the first scale indicator is more than or equal to a first threshold, the pixel neighborhood including a first pixel different from the first person point.

The first processing unit may be configured to determine a position of the first pixel as the person point tag of the first person.

A third aspect provides a processor, which may be configured to execute the method in the first aspect and any possible implementation mode thereof.

A fourth aspect provides an electronic device, which may include a processor, a sending apparatus, an input apparatus, an output apparatus, and a memory. The memory may be configured to store computer program codes. The computer program codes may include computer instructions. When the processor executes the computer instructions, the electronic device may execute the method in the first aspect and any possible implementation mode thereof.

A fifth aspect provides a computer-readable storage medium, in which a computer program may be stored. The computer program may include program instructions, and the program instructions may be executed by a processor to enable the processor to execute the method in the first aspect and any possible implementation mode thereof.

A sixth aspect provides a computer program, which may include computer-readable codes. When the computer-readable codes run in an electronic device, a processor in the electronic device may execute the method in the first aspect and any possible implementation mode thereof.

It is to be understood that the above general description and the following detailed description are only exemplary and explanatory and not intended to limit the disclosure.

### BRIEF DESCRIPTION OF THE DRAWINGS

In order to describe the technical solutions in the embodiments of the disclosure or a background art more clearly, the drawings required to be used for descriptions about the embodiments of the disclosure or the background art will be described below.

The accompanying drawings, which are incorporated in and constitute a part of this specification, illustrate embodiments consistent with the disclosure and, together with the specification, serve to describe the technical solutions of the disclosure.

FIG. 1 is a schematic diagram of a crowd image according to embodiments of the disclosure.

FIG. 2 is a schematic diagram of a pixel coordinate system according to embodiments of the disclosure.

FIG. 3 is a flowchart of an image labeling method according to embodiments of the disclosure.

FIG. 4 is a schematic diagram of an image according to embodiments of the disclosure.

FIG. 5 is a schematic diagram of an image to be labeled according to embodiments of the disclosure.

FIG. 6 is a flowchart of another image labeling method according to embodiments of the disclosure.

FIG. 7 is a flowchart of another image labeling method according to embodiments of the disclosure.

FIG. 8 is a schematic diagram of a sign according to embodiments of the disclosure.

FIG. 9 is a flowchart of another image labeling method according to embodiments of the disclosure.

FIG. 10 is a schematic diagram of elements at the same positions according to embodiments of the disclosure.

FIG. 11 is a structure diagram of a crowd positioning network according to embodiments of the disclosure.

FIG. 12 is a structure diagram of a backbone network according to embodiments of the disclosure.

FIG. 13 is a structure diagram of a person point branch and a person box branch according to embodiments of the disclosure.

FIG. 14 is a structure diagram of an apparatus for image labeling according to embodiments of the disclosure.

FIG. 15 is a hardware structure diagram of an apparatus for image labeling according to embodiments of the disclosure.

### DETAILED DESCRIPTION

At present, the position of the pixel in the person region in the training image may be labeled by manual labeling to obtain a person point tag. However, the person point tag is low in accuracy.

According to the methods provided in the embodiments of the disclosure, whether there is any unlabeled pixel in a person region is determined according to a labeled person point and a scale indicator of the labeled person point. Under the condition that there is an unlabeled pixel in the person region, a pixel neighborhood is constructed based on the labeled person point, and a position of a pixel, except the labeled person point, in the pixel neighborhood is determined as a tag of a person corresponding to the person region. Therefore, the labeling accuracy is improved.

In order to make the technical solutions provided in the embodiments of the disclosure understood by those skilled in the art, the technical solutions in the embodiments of the disclosure will be clearly and completely described below in combination with the drawings in the embodiments of the disclosure. It is apparent that the described embodiments are not all but only part of embodiments of the disclosure. All other embodiments obtained by those of ordinary skill in the art on the basis of the embodiments in the disclosure without creative work shall fall within the scope of protection of the disclosure.

Terms “first”, “second” and the like in the specification, claims and drawings of the disclosure are adopted not to describe a specific sequence but to distinguish different objects. In addition, terms “include” and “have” and any transformations thereof are intended to cover nonexclusive inclusions. For example, a process, method, system, product, or device including a series of steps or units is not limited to the steps or units which have been listed but optionally further includes steps or units which are not listed or optionally further includes other steps or units intrinsic to the process, the method, the product, or the device.

“Embodiment” mentioned herein means that a specific feature, structure or characteristic described in combination with an embodiment may be included in at least one embodiment of the disclosure. The phrase appearing anywhere in the specification does not always refer to the same embodiment or an independent or alternative embodiment mutually exclusive of another embodiment. It is explicitly and implicitly understood by those skilled in the art that the embodiments described in the disclosure may be combined with other embodiments.

Some concepts to be mentioned below are defined at first. In some possible implementation modes, a close person in an image corresponds to a large image scale, and a distant person in the image corresponds to a small image scale. In the embodiments of the disclosure, “distant” refers to that a real person corresponding to the person in the image is at a long distance away from an imaging device that collects the image, and “close” refers to that a real person corresponding to the person in the image is at a short distance away from the imaging device that collects the image.

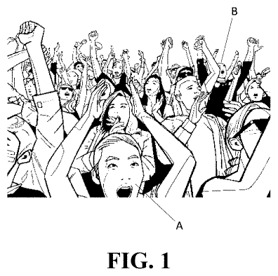

In an image, an area of a pixel region covered by a close person is far larger than an area of a pixel region covered by a distant person. For example, in FIG. 1, person A, compared with person B, is a close person, and an area of a pixel region covered by person A is larger than an area of a pixel region covered by person B. A scale of the pixel region covered by the close person is large, and a scale of the pixel region covered by the distant person is small. That is, an area of a pixel region covered by a person is positively correlated with a scale of the pixel region covered by the person.

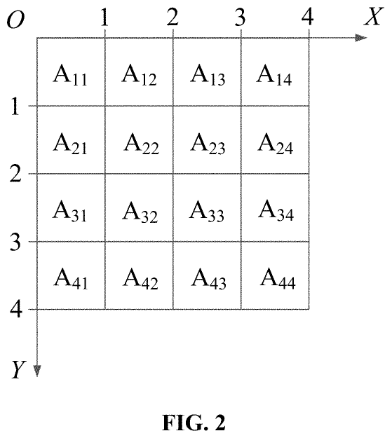

In some possible implementation modes, a position in an image refers to a position based on a pixel coordinate of the image. In the embodiments of the disclosure, the abscissa of a pixel coordinate system is used to represent the column where the pixel is located, and the ordinate of the pixel coordinate system is used to represent the row where the pixel is located. For example, in an image shown in FIG. 2, pixel coordinate system XOY is constructed by taking a top left corner of the image as a coordinate origin O, taking a direction parallel to a row of the image as a direction of an X axis, and taking a direction parallel to a column of the image as a direction of a Y direction. Both the abscissa and the ordinate take pixel as the unit. For example, in FIG. 2, a coordinate of pixel A₁₁ is (1, 1), a coordinate of A₂₃ is (3, 2), a coordinate of pixel A₄₂ is (2, 4), a coordinate of pixel A₃₄ is (4, 3), and so on.

In some possible implementation modes, [a, b] represents a value interval greater than or equal to a and less than or equal to b, (c, d] represents a value interval greater than c and less than or equal to d, and [e, f) represents a value interval greater than or equal to e and less than f.

An execution body of the embodiments of the disclosure is an image labeling apparatus. Optionally, the image labeling apparatus may be one of a mobile phone, a computer, a server, and a tablet computer. The embodiments of the disclosure will be described below in combination with the drawings in the embodiments of the disclosure.

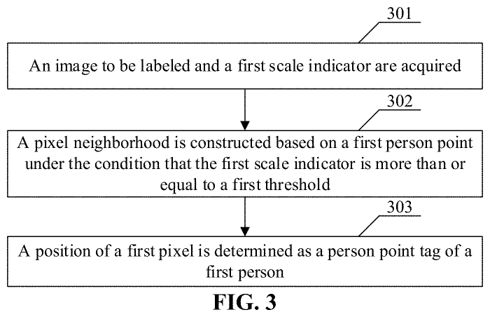

References are made to FIG. 3. FIG. 3 is a flowchart of an image labeling method according to embodiments of the disclosure.

In 301, an image to be labeled and a first scale indicator are acquired.

In some possible implementation modes, the image to be labeled may be any image. For example, the image to be labeled may include a person. The image to be labeled may include no trunk and limbs (the trunk and the limbs are called a human body hereinafter) but only a head. The image to be labeled may also include no head but only a human body. The image to be labeled may also include lower limbs or upper limbs only. A human body region in the image to be labeled is not limited in the embodiments of the disclosure. For another example, the image to be labeled may include an animal. For another example, the image to be labeled may include a plant. The content in the image to be labeled is not limited in the embodiments of the disclosure.

In the image to be labeled, a pixel region covered by a person point may be considered as a person region, the person region being a pixel region covered by a human body. For example, a region covered by a first person point belongs to a pixel region covered by the head. For another example, the region covered by the first person point belongs to a pixel region covered by the arm. For another example, the region covered by the first person point belongs to a pixel region covered by the trunk.

In some possible implementation modes, the image to be labeled contains a person point tag of a first person. The person point tag of the first person includes a first position of the first person point. That is, the first position in the image to be labeled is a person region of the first person.

In some possible implementation modes, a scale indicator (including the abovementioned first scale indicator, and a second scale indicator, third scale indicator, and fourth scale indicator that will appear hereinafter) at a certain position in an image represents a mapping relationship between a size of an object at the position and a size of and a size of the object in a real world.

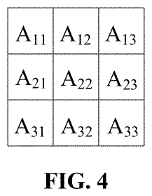

In a possible implementation mode, a scale indicator of a certain position represents the number of pixels required to represent 1 meter in the real world at the position. For example, there is made such a hypothesis that, in an image shown in FIG. 4, a scale indicator of a position of pixel A₃₁ is 50, and a scale indicator of a position of pixel A₁₃ is 20. In such case, the number of pixels required to represent 1 meter in the real world at the position of pixel A₃₁ is 50, and the number of pixels required to represent 1 meter in the real world at the position of A₁₃ is 20.

In another possible implementation mode, a scale indicator of a certain position represents a ratio of a size of an object at the position to a size of the object in the real world. For example, there is made such a hypothesis that, in the image shown in FIG. 4, object 1 is at a position of pixel A₁₃, object 2 is at a position of pixel A₃₁, a scale indicator of the position of pixel A₃₁ is 50, and a scale indicator of the position of pixel A₁₃ is 20. In such case, a ratio of a size of object 1 in the image to a size of object 1 in the real world is 20, and a ratio of a size of object 2 in the image to a size of object 2 in the real world is 50.

In another possible implementation mode, a scale indicator of a certain position represents a reciprocal of a ratio of a size of an object at the position to a size of the object in the real world. For example, there is made such a hypothesis that, in the image shown in FIG. 4, object 1 is at a position of pixel A₁₃, object 2 is at a position of pixel A₃₁, a scale indicator of the position of pixel A₃₁ is 50, and a scale indicator of the position of pixel A₁₃ is 20. In such case, a ratio of a size of object 1 in the real world to a size of object 1 in the image is 20, and a ratio of a size of object 2 in the real world to a size of object 2 in the image is 50.

Optionally, scale indicators at positions of the same scale are the same. For example, in the image shown in FIG. 4, a scale of pixel A₁₁, a scale of pixel A₁₂, and a scale of pixel A₁₃ are the same, a scale of pixel A₂₁, a scale of pixel A₂₂, and a scale of pixel A₂₃ are the same, and a scale of pixel A₃₁, a scale of pixel A₃₂, and a scale of pixel A₃₃ are the same. Correspondingly, a scale indicator of pixel A₁₁, a scale indicator of pixel A₁₂, and a scale indicator of pixel A₁₃ are the same, a scale indicator of pixel A₂₁, a scale indicator of pixel A₂₂, and a scale indicator of pixel A₂₃ are the same, and a scale indicator of pixel A₃₁, a scale indicator of pixel A₃₂, and a scale indicator of pixel A₃₃ are the same.

In some possible implementation modes, the first scale indicator is a scale indicator of the first position. If a first reference object is at the first position, the first scale indicator represents a mapping between a first size and a second size. Herein, the first size is a size of the first reference object in the image to be labeled, and the second size is a size of the first reference object in the real world.

In an implementation mode of acquiring the image to be labeled, the image labeling apparatus receives the image to be labeled input by a user through an input component. The input component includes a keyboard, a mouse, a touch screen, a touch pad, an audio input unit, etc.

In another implementation mode of acquiring the image to be labeled, the image labeling apparatus receives the image to be labeled sent by a first terminal. Optionally, the first terminal may be any one of a mobile phone, a computer, a tablet computer, a server, and a wearable device.

In another implementation mode of acquiring the image to be labeled, the image labeling apparatus may acquire the image to be labeled through an imaging component. Optionally, the imaging component may be a camera.

In an implementation mode of acquiring the first scale indicator, the image labeling apparatus receives the first scale indicator input by the user through the input component. The input component includes a keyboard, a mouse, a touch screen, a touch pad, an audio input unit, etc.

In another implementation mode of acquiring the first scale indicator, the image labeling apparatus receives the first scale indicator sent by a second terminal. Optionally, the second terminal may be any one of a mobile phone, a computer, a tablet computer, a server, and a wearable device. The second terminal may be the same as or different from the first terminal.

In 302, a pixel neighborhood is constructed based on a first person point under the condition that the first scale indicator is greater than or equal to a first threshold.

In a conventional image labeling method, a position of a pixel in a person region in an image to be labeled is labeled by manual labeling to obtain a person point tag. Since there may be a relatively large person region in the image to be labeled, person point tag (for example, the person point tag contained in the image to be labeled) obtained by the conventional method may not cover the whole person region.

An area of a person region farer away from an x axis of a pixel coordinate system in the image to be labeled is larger, while a scale indicator of a certain position in the image to be labeled may be used to represent a distance between the position and the x axis. In consideration of this, the image labeling apparatus determines a distance between a person region and the x axis according to a scale indicator to further determine whether there is any unlabeled pixel in the person region.

Since a “scale indicator” at a certain position in the image to be labeled is positively correlated with a “distance between the position and the x axis”, the image labeling apparatus determines whether there is any unlabeled pixel in a person region at the position according to whether the scale indicator is more than or equal to a first threshold.

In a possible implementation mode, it indicates that there is an unlabeled pixel in the person region of the first person when the first scale indicator is greater than or equal to the first threshold. Optionally, a magnitude of the first threshold may be determined as practically required. Optionally, the first threshold is 16.

An unlabeled pixel in a person region is usually close to a boundary of the person region, and a labeled pixel in the person region is usually close to a center of the person region. Therefore, under the condition of determining that there is an unlabeled pixel in the person region, the image labeling apparatus may construct a pixel neighborhood based on the labeled pixels, so that the pixel neighborhood includes pixels except the labeled pixels, and label the pixels except the labeled pixels.

In a possible implementation mode, the image labeling apparatus constructs the pixel neighborhood based on the first person point under the condition that the first scale indicator is greater than or equal to the first threshold. The pixel neighborhood includes at least one pixel (for example, a first pixel) different from the first person point.

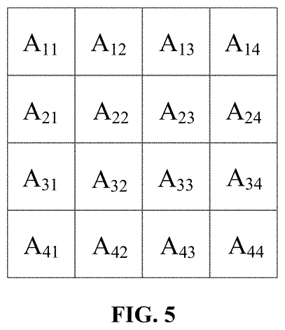

In some possible implementation modes, the manner for constructing the pixel neighborhood is not limited. For example, there is made such a hypothesis that the first person point in the image to be labeled shown in FIG. 5 is pixel A₃₂. The image labeling apparatus may construct the pixel neighborhood by taking a pixel at a distance of 1 pixel away from pixel A₃₂ as a pixel in the pixel neighborhood. Based on pixel A₃₂, the pixel neighborhood includes pixel A₂₁, pixel A₂₂, pixel A₂₃, pixel A₃₁, pixel A₃₂, pixel A₃₃, pixel A₄₁, pixel A₄₂, and pixel A₄₃.

The image labeling apparatus may also construct a pixel neighborhood with a size of 2*2 based on the first person point. Based on pixel A₃₂, the pixel neighborhood includes pixel A₂₁, pixel A₂₂, pixel A₃₁, and pixel A₃₂.

The image labeling apparatus may also construct the pixel neighborhood by taking pixel A₃₂ as a circle center and 1.5 pixels as a radius. Based on pixel A₃₂, the pixel neighborhood includes a partial region of pixel A₂₁, pixel A₂₂, a partial region of pixel A₂₃, pixel A₃₁, pixel A₃₂, pixel A₃₃, a partial region of pixel A₄₁, pixel A₄₂, and a partial region of pixel A₄₃.

If an area of a person region is larger, there may be more unlabeled pixels in the person region. Therefore, as an optional implementation mode, under the condition that the first scale indicator is in [first threshold, second threshold), the pixel neighborhood is constructed by taking a pixel at a distance of 1 pixel away from the first person point as a pixel in the pixel neighborhood, and under the condition that the first scale indicator is greater than or equal to the second threshold, the pixel neighborhood is constructed by taking a pixel at a distance of 2 pixels away from the first person point as a pixel in the pixel neighborhood.

In 303, a position of a first pixel is determined as a person point tag of a first person.

After constructing the pixel neighborhood based on the first person point, the image labeling apparatus may label the first pixel, namely the position of the first pixel is determined as the person point tag of the first person.

Optionally, the image labeling apparatus may label all pixels, except the first person point, in the pixel neighborhood, namely positions of all the pixels, except the first person point, in the pixel neighborhood are determined as the person point tag of the first person.

In some possible implementation modes, whether there is any unlabeled pixel in a person region is determined according to a labeled person point and a scale indicator of the labeled person point. Under the condition that there is an unlabeled pixel in the person region, a pixel neighborhood is constructed based on the labeled person point, and a position of a pixel, except the labeled person point, in the pixel neighborhood is determined as a tag of a person corresponding to the person region. Therefore, the labeling accuracy is improved.

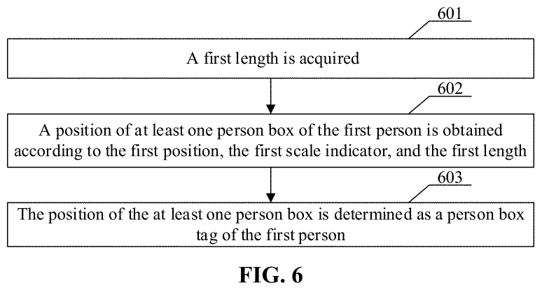

References are made to FIG. 6. FIG. 6 is a flowchart of another image labeling method according to embodiments of the disclosure.

In 601, a first length is acquired.

In some possible implementation modes, the first length is a length of the first person in the real world. For example, the first length may be a height of the first person in the real world. For another example, the first length may be a length of the face of the first person in the real world. For another example, the first length may be a length of the head of the first person in the real world.

In an implementation mode of acquiring the first length, the image labeling apparatus receives the first length input by the user through the input component. The input component includes a keyboard, a mouse, a touch screen, a touch pad, an audio input unit, etc.

In another implementation mode of acquiring the first length, the image labeling apparatus receives the first length sent by a third terminal. Optionally, the third terminal may be any one of a mobile phone, a computer, a tablet computer, a server, and a wearable device. The third terminal may be the same as or different from the first terminal.

In 602, a position of at least one person box of the first person is obtained according to the first position, the first scale indicator, and the first length.

In some possible implementation modes, a pixel region in a person box may be considered as a person region. For example, the person box of the first person includes the person region of the first person.

In some possible implementation modes, the person box may be in any shape. The shape of the person box is not limited in the embodiments of the disclosure. Optionally, a shape of the person box includes at least one of a rectangle, a rhombus, a round, an ellipse, and a polygon.

In some possible implementation modes, a representation form of the position of the person box in the image to be labeled may be determined according to the shape of the person box. For example, under the condition that the shape of the person box is a rectangle, the position of the person box may include coordinates of any pair of opposite angles in the person box. A pair of opposite angles refer to two vertexes on a diagonal of the person box. For another example, under the condition that the shape of the person box is a rectangle, the position of the person box may include a position of a geometric center of the person box, a length of the person box, and a width of the person box. For another example, under the condition that the shape of the person box is a round, the position of the person box may include a circle center of the person box and a radius of the person box.

The position of the at least one person box of the first person may be obtained according to the first position, the first scale indicator, and the first length. An implementation process of obtaining the position of the person box according to the first position, the first scale indicator, and the first length will be described below in detail taking obtaining of a first person box as an example.

In a possible implementation mode, a product of the first scale indicator and the first length may be calculated to obtain a second length of the first person in the image to be labeled. A position of the first person box may be determined as a second position according to the first position and the second length. Herein, a center of the first person box is the first person point, and a maximum length of the first person box in a y-axis direction is not less than the second length.

In some possible implementation modes, a y axis is an ordinate axis of the pixel coordinate system of the image to be labeled. The meaning of the maximum length in the y-axis direction may refer to the following example. For example, rectangular box abcd is person box 1, where a coordinate of a is (4, 8), a coordinate of b is (6, 8), a coordinate of c is (6, 12), and a coordinate of d is (4, 12). A length of person box 1 in the y-axis direction is 12−8=4.

In an implementation mode of determining the position of the first person box, a coordinate of a diagonal vertex of the first person box is determined according to the first position and the second length. The coordinate of the diagonal vertex is determined as the position of the first person box.

In some possible implementation modes, the diagonal vertex includes a first vertex and a second vertex, and the first vertex and the second vertex are two vertexes on any diagonal of the first person box. For example, the diagonal of the first person box includes a first line segment, the diagonal vertex includes the first vertex and the second vertex, and both the first vertex and the second vertex are points on the first line segment.

Optionally, there is made such a hypothesis that a coordinate of the first position under the pixel coordinate system of the image to be labeled is (p, q). A half of the second length is calculated to obtain a third length. A difference between p and the third length is determined to obtain a first abscissa, a difference between q and the third length is determined to obtain a first ordinate, a sum of p and the third length is determined to obtain a second abscissa, and a sum of q and the third length is determined to obtain a second ordinate.

The first abscissa is determined as an abscissa of the first vertex, the first ordinate is determined as an ordinate of the first vertex, the second abscissa is determined as an abscissa of the second vertex, and the second ordinate is determined as an ordinate of the second vertex.

For example, p=20, and q=18, namely the coordinate of the first position is (20, 18). If the second length is 20, namely the third length is 10, the first abscissa is 20-10=10, the first ordinate is 18−10=8, the second abscissa is 20+10=30, and the second ordinate is 18+10=28. In such case, a coordinate of the first vertex is (10, 8), and a coordinate of the second vertex is (30, 28) is determined.

Optionally, there is made such a hypothesis that a coordinate of the first position under the pixel coordinate system of the image to be labeled is (p, q). A half of the second length is calculated to obtain the third length. The sum of p and the third length is determined to obtain a third abscissa, the difference of q and the third length is determined to obtain a third ordinate, the difference of p and the third length is determined to obtain a fourth abscissa, and the sum of q and the third length is determined to obtain a fourth ordinate.

The third abscissa is determined as the abscissa of the first vertex, the third ordinate is determined as the ordinate of the first vertex, the fourth abscissa is determined as the abscissa of the second vertex, and the fourth ordinate is determined as the ordinate of the second vertex.

For example, p=20, and q=18, namely the coordinate of the first position is (20, 18). If the second length is 20, namely the third length is 10, the third abscissa is 20+10=30, the third ordinate is 18−10=8, the fourth abscissa is 20−10=10, and the fourth ordinate is 18+10=28. In such case, the coordinate of the first vertex is (30, 8), and the coordinate of the second vertex is (10, 28) is determined.

In another implementation mode of determining the position of the first person box, the position of the first person box is determined as the second position according to the first position and the second length. A shape of the first person box is a round, a circle center of the first person box is the first person point, and a diameter of the first person box is the second length.

In another implementation mode of determining the position of the first person box, the position of the first person box is determined as the second position according to the first position and the second length. The shape of the first person box is a rectangle, the center of the first person box is the first person point, a length of the first person box is a product of a first value and the second length, and a width of the first person box is a product of a second value and the second length. Optionally, the first value is 1, and the second value is ¼.

In 603, the position of the at least one person box is determined as a person box tag of the first person.

In some possible implementation modes, the position of the person box is obtained according to the labeled person point and the scale indicator of the labeled person point. The position of the person box is determined as the tag of the corresponding person, thereby labeling the image to be labeled with the person box tag.

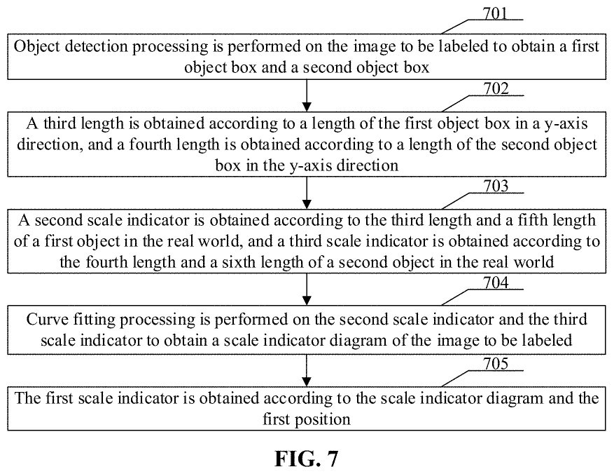

References are made to FIG. 7. FIG. 7 is a flowchart of a possible implementation method of acquiring a first scale indicator according to embodiments of the disclosure.

In 701, object detection processing is performed on the image to be labeled to obtain a first object box and a second object box.

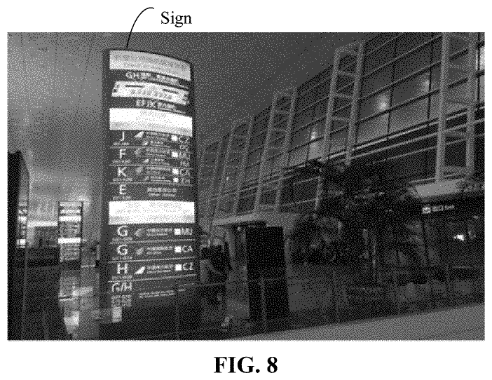

In some possible implementation modes, a length of a detection target of object detection processing in the real world is close to a constant value. For example, an average length of faces is 20 centimeters, and the detection target of object detection processing may be a face. For another example, an average height of persons is 1.65 meters, and the detection target of object detection processing may be a human body. For another example, heights of all signs shown in FIG. 8 in a departure lounge are constant (for example, 2.5 meters), and the detection target of object detection processing may be a sign. Optionally, object detection processing is face detection processing.

In a possible implementation mode, object detection processing over the image to be labeled may be implemented through a convolutional neural network. The convolutional neural network is trained by taking an image with labeling information as training data such that the trained convolutional neural network may complete object detection processing over an image. The labeling information of the image in the training data is position information of an object box, and the object box includes a detection target of object detection processing.

In another possible implementation mode, object detection processing may be implemented through a person detection algorithm. The person detection algorithm may be one of You Only Look Once (YOLO), Deformable Part Model (DMP), Single Shot multi-Box Detector (SSD), Faster-Region Convolutional Neural Network (RCNN) algorithm, etc. The person detection algorithm for implementing object detection processing is not limited in the embodiments of the disclosure.

In some possible implementation modes, a detection target in the first object box is different from a detection target in the second object box. For example, the detection target in the first object box is the face of Zhang San, and the detection target in the second object box is the face of Li Si. For another example, the detection target in the first object box is the face of Zhang San, and the detection target in the second object box is a sign.

In 702, a third length is obtained according to a length of the first object box in a y-axis direction, and a fourth length is obtained according to a length of the second object box in the y-axis direction.

The image labeling apparatus may obtain the length of the first object box in the y-axis direction, i.e., the third length, according to a position of the first object box. Image processing may obtain the length of the second object box in the y-axis direction, i.e., the fourth length, according to a position of the second object box.

In 703, a second scale indicator is obtained according to the third length and a fifth length of a first object in the real world, and a third scale indicator is obtained according to the fourth length and a sixth length of a second object in the real world.

In some possible implementation modes, the second scale indicator is a scale indicator of a second-scale position. Herein, the second-scale position is a position determined in the image to be labeled according to the position of the first object box. If a second reference object is at the second-scale position, the second scale indicator represents a mapping between a third size and a fourth size. Herein, the third size is a size of the second reference object in the image to be labeled, and the fourth size is a size of the second reference object in the real world. The third scale indicator is a scale indicator of a third-scale position. Herein, the third-scale position is a position determined in the image to be labeled according to the position of the second object box. If a third reference object is at the third-scale position, the third scale indicator represents a mapping between a fifth size and a sixth size. Herein, the fifth size is a size of the third reference object in the image to be labeled, and the sixth size is a size of the third reference object in the real world.

In some possible implementation modes, an object point may be determined according to a position of an object box. For example, a shape of object box 1 is a rectangle. The image labeling apparatus may determine a position of any vertex of object box 1 according a position of object box 1, and may further determine any vertex of object box 1 as an object point.

For another example, a shape of object box 1 is rectangle abcd. A center of the rectangle abcd is point e. The image labeling apparatus may determine a coordinate of the point e according to the position of the object box 1 and further determine the point e as an object point.

For another example, a shape of object box 1 is a round. The image labeling apparatus may determine a position of any point on the round according the position of object box 1, and may further determine any point on the round as an object point.

The image labeling apparatus determines a first object point according to the position of the first object box. The image labeling apparatus determines a second object point according to the position of the second object box.

Optionally, the first object point is one of a geometric center of the first object box and a vertex of the first object box. The second object point is one of a geometric center of the second object box and a vertex of the second object box.

After determining a position of the first object point and a position of the second object point, the image labeling apparatus may determine the position of the first object point as the second-scale position and determine the position of the second object point as the third-scale position.

In some possible implementation modes, both the first object and the second object are detection targets of object detection processing. The first object is the detection target in the first object box, and the second object is the detection target in the second object box. A length of the first object in the real world is the fifth length, and the length of the second object in the real world is the sixth length. For example, both the first object and the second object are faces, and both the fifth length and the sixth length may be 20 centimeters. For another example, the first object is a face, the second object is a human body, the fifth length may be 20 centimeters, and the sixth length may be 170 centimeters.

There is made such a hypothesis that the third length is l₁, the fourth length is l₂, the fifth length is l₃, the sixth length is l₄, the second scale indicator is i₂, and the third scale indicator is i₃.

In a possible implementation mode, l₁, l₂, l₃, l₄, i₂, and i₃ satisfy formula (1).

$$\{ \begin{matrix}{i}_{2} = k \times {l}_{1} / {l}_{3} \\ {i}_{3} = k \times {l}_{2} / {l}_{4}\end{matrix} . \qquad Formula ( 1 )$$

k is a positive number. Optionally, k=1

In another possible implementation mode, l₁, l₂, l₃, l₄, i₂, and i₃ satisfy formula (2).

$$\{ \begin{matrix}{i}_{2} = k \times {l}_{1} / {l}_{3} + t \\ {i}_{3} = k \times {l}_{2} / {l}_{4} + t\end{matrix} . \qquad Formula ( 2 )$$

k is a positive number, and t is a real number. Optionally, k=1, and t=0.

In another possible implementation mode, l₁, l₂, l₃, l₄, i₂, and i₃ satisfy formula (3).

$$\{ \begin{matrix}{i}_{2} = k \times {l}_{1} / {l}_{3} + t \\ {i}_{3} = k \times {l}_{2} / {l}_{4} + t\end{matrix} . \qquad Formula ( 3 )$$

k is a positive number, and t is a real number. Optionally, k=1, and t=0.

In 704, curve fitting processing is performed on the second scale indicator and the third scale indicator to obtain a scale indicator diagram of the image to be labeled.

A relationship between a scale and an ordinate in the image to be labeled may be considered as linear correlation, and a scale indicator is used to represent a scale. Therefore, the image labeling apparatus may perform curve fitting processing on the second scale indicator and the third scale indicator to obtain the scale indicator diagram of the image to be labeled. The scale indicator diagram includes a scale indicator of a position of any pixel in the image to be labeled.

A second pixel in the scale indicator diagram is taken as an example. If a pixel value (i.e., a first pixel value) of the second pixel is 40, and a position of the second pixel in the scale indicator diagram is the same as a position of a third pixel in the image to be labeled, a scale indicator (i.e., a fourth-scale position) of the position of the third pixel in the image to be labeled is the first pixel value. If a fourth reference object is at the fourth-scale position, the first pixel value represents a mapping between a seventh size and an eighth size. Herein, the seventh size is a size of the fourth reference object at the fourth-scale position, and the eighth size is a size of the fourth reference object in the real world.

In 705, the first scale indicator is obtained according to the scale indicator diagram and the first position.

As described in 704, the scale indicator diagram includes the scale indicator of the position of any pixel in the image to be labeled. Therefore, a scale indicator, i.e., the first scale indicator, of the first person object may be determined according to the scale indicator diagram and the first position.

In some possible implementation modes, the second scale indicator is obtained according to the third length and the fifth length, and the third scale indicator is obtained according to the fourth length and the sixth length. Curve fitting processing is performed on the second scale indicator and the third scale indicator to obtain the scale indicator diagram, and the scale indicator of the position of any pixel in the image to be labeled may further be determined according to the scale indicator diagram.

As an optional implementation mode, the person point (including the first person point) in the embodiments of the disclosure may be a head point, and the person box (including the first person box) may be a head box. Both a pixel region covered by the head point and a pixel region in the head box are the head region.

As an optional implementation mode, after the image labeling apparatus obtains the person box tag based on a labeled person point tag, the image to be labeled may be used as training data to train the neural network. An execution body of such a training method may be the image labeling apparatus, or may not be the labeling apparatus. The execution body of the training method is not limited in the embodiments of the disclosure. For ease of expression, the execution body of a training process is called a training apparatus hereinafter. Optionally, the training apparatus may be any one of a mobile phone, a computer, a tablet computer, a server, and a processor.

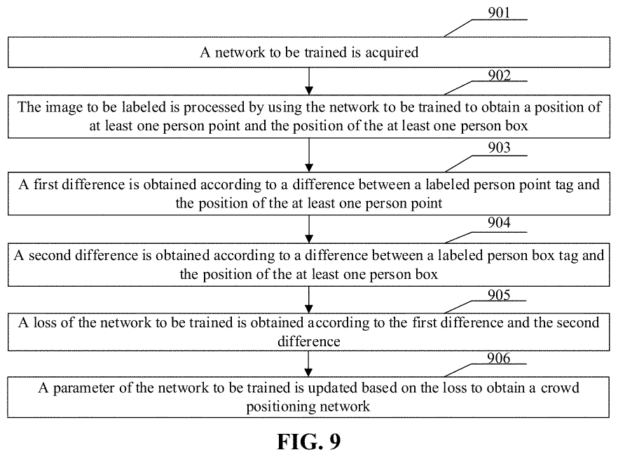

References are made to FIG. 9. FIG. 9 is a flowchart of a neural network training method according to embodiments of the disclosure.

In 901, a network to be trained is acquired.

In some possible implementation modes, the network to be trained may be any neural network. For example, the network to be trained may be formed by stacking at least one network layer of the following: a convolutional layer, a pooling layer, a normalization layer, a fully connected layer, a down-sampling layer, and an up-sampling layer. A structure of the network to be trained is not limited in the embodiments of the disclosure.

In an implementation mode of acquiring the network to be trained, the training apparatus receives the network to be trained input by the user through the input component. The input component includes a keyboard, a mouse, a touch screen, a touch pad, an audio input unit, etc.

In another implementation mode of acquiring the network to be trained, the training apparatus receives the network to be trained sent by a fourth terminal. Optionally, the fourth terminal may be any one of a mobile phone, a computer, a tablet computer, a server, and a wearable device. The fourth terminal may be the same as or different from the first terminal. No limits are made thereto in the embodiments of the disclosure.

In another implementation mode of acquiring the network to be trained, the training apparatus may acquire the network to be trained pre-stored in its own storage component.

In 902, the image to be labeled is processed by using the network to be trained to obtain a position of at least one person point and the position of the at least one person box.

The training apparatus may process the image to be labeled including at least one person by using the network to be trained to obtain a position of at least one person point of each person and a position of at least one person box of each person.

In a possible implementation mode, feature extraction processing is performed on the image to be labeled by using the neural network to be trained to obtain first feature data. Down-sampling processing is performed on the first feature data to obtain the position of the at least one person box. Up-sampling processing is performed on the first feature data to obtain the position of the at least one person point.

In some possible implementation modes, feature extraction processing may be convolution processing, or may be pooling processing, or may be a combination of convolution processing and pooling processing. An implementation mode of feature extraction processing is not limited in the embodiments of the disclosure.

Optionally, stepwise convolution processing is performed on the image to be labeled sequentially through multiple convolutional layers to implement feature extraction processing over the image to be labeled to obtain the first feature data containing semantic information of the image to be labeled.

Optionally, down-sampling processing includes one or combination of convolution processing and pooling processing. For example, down-sampling processing is convolution processing. For another example, down-sampling processing may be pooling processing. For another example, down-sampling processing may be convolution processing and pooling processing.

Optionally, up-sampling processing includes at least one of bilinear interpolation processing, nearest neighbor interpolation processing, high-order interpolation, and deconvolution processing.

As an optional implementation mode, the training apparatus may execute the following operations to implement down-sampling processing on the first feature data to obtain the position of the at least one person box.

In step 1, down-sampling processing is performed on the first feature data to obtain second feature data.

The training apparatus may perform down-sampling processing on the first feature data to reduce a size of the first feature data and simultaneously extract the semantic information in the first feature data (i.e., the semantic information of the image to be labeled) to obtain the second feature data.

In step 2, convolution processing is performed on the second feature data to obtain the position of the at least one person box.

The training apparatus may perform convolution processing on the second feature data to obtain the position of the at least one person box using the semantic information contained in the second feature data.

Under the condition of executing 1 and 2 to obtain the position of the at least one person box, the training apparatus may execute the following operations to implement up-sampling processing on the first feature data to obtain the position of the at least one person box.

In step 3, up-sampling processing is performed on the first feature data to obtain the third feature data.

Since a distance between persons in the image to be labeled may be very short, while the image labeling apparatus performs feature extraction processing on the image to be labeled to reduce a size of the image to be labeled and simultaneously extract the first feature data, at least two person regions in the first feature data may overlap. This may clearly reduce the accuracy of the subsequently obtained person point. In the present step, the training apparatus performs up-sampling processing on the first feature data to enlarge the size of the first feature data and further reduce the probability that at least two person regions overlap.

In step 4, fusion processing is performed on the second feature data and the third feature data to obtain fourth feature data.

The person box tag of the image to be labeled contains scale information of the image to be labeled (including scales of different positions in the image to be labeled). Therefore, under the condition of obtaining the position of the at least one person box by using the person box tag based on step 2, the second feature data may also contain the scale information of the image to be labeled. The training apparatus may perform fusion processing on the second feature data and the third feature data to enrich scale information in the third feature data to obtain the fourth feature data.

As an optional implementation mode, under the condition that a size of the second feature data is smaller than a size of the third feature data, the training apparatus performs up-sampling processing on the second feature data using the network to be trained to obtain fifth feature data with the same size as the third feature data. Fusion processing is performed on the fifth feature data and the third feature data to obtain the fourth feature data.

Optionally, fusion processing may be one of concatenate in a channel dimension and summation of elements at the same positions.

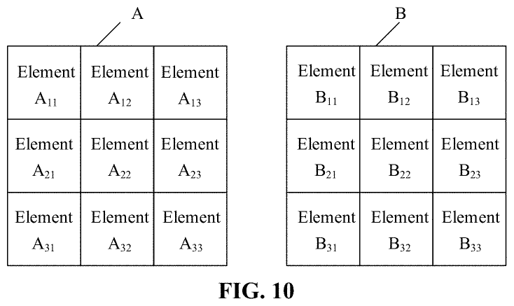

In some possible implementation modes, elements at the same positions in two pieces of data may refer to the following example. For example, as shown in FIG. 10, a position of element A₁₁ in data A is the same as a position of element B₁₁ in data B, a position of element A₁₂ in data A is the same as a position of element k in data B₁₂, a position of element A₁₃ in data A is the same as a position of element B₁₃ in data B, a position of element A₂₁ in data A is the same as a position of element B₂₁ in data B, a position of element A₂₂ in data A is the same as a position of element B₂₂ in data B, a position of element A₂₃ in data A is the same as a position of element B₂₃ in data B, a position of element A₃₁ in data A is the same as a position of element B₃₁ in data B, a position of element A₃₂ in data A is the same as a position of element B₃₂ in data B, and a position of element A₃₃ in data A is the same as a position of element B₃₃ in data B.

In step 5, up-sampling processing is performed on the fourth feature data to obtain the position of the at least one person point.

The training apparatus may perform up-sampling processing on the fourth feature data to obtain the position of the at least one person point by using the semantic information contained in the fourth feature data.

The fourth feature data contains the scale information of the image to be labeled, so that performing up-sampling processing on the fourth feature data to obtain the position of the at least one person point may improve the accuracy of the position of the at least one person point.

In 903, a first difference is obtained according to a difference between a labeled person point tag and the position of the at least one person point.

Optionally, the labeled person point tag and the position of the at least one person point may be substituted into a binary cross entropy loss function to obtain the first difference.

For example, the labeled person point tag includes a position of person point a and a position of person point b. The at least one person point includes a position of person point c and a position of person point d. Both person point a and person point c are person points of the first person, and both person point b and person point d are person points of the second person. The position of person point a and the position of person point c are substituted into the binary cross entropy loss function to obtain difference A. The position of person point b and the position of person point d are substituted into the binary cross entropy loss function to obtain difference B. Herein, the first difference may be difference A, or the first difference may be difference B, or the first difference may be a sum of difference A and difference B.

As an optional implementation mode, the image labeling apparatus may execute the following operation before executing 903.

In step 6, a fourth scale indicator is acquired.

In some possible implementation modes, the labeled person point tag in the image to be labeled further comprises a person point tag of a second person. The person point tag of the second person includes a third position of a second person point.

In some possible implementation modes, the fourth scale indicator is a scale indicator of the third position. If a fifth reference object is at the third position, the fourth scale indicator represents a mapping between a ninth size and a tenth size. Herein, the ninth size is a size of the fifth reference object in the image to be labeled, and the tenth size is a size of the fifth reference object in the real world.

In an implementation mode of acquiring the fourth scale indicator, the image labeling apparatus receives the fourth scale indicator input by the user through the input component. The input component includes a keyboard, a mouse, a touch screen, a touch pad, an audio input unit, etc.

In another implementation mode of acquiring the fourth scale indicator, the image labeling apparatus receives the fourth scale indicator sent by the fifth terminal. Optionally, the fifth terminal may be any one of a mobile phone, a computer, a tablet computer, a server, and a wearable device. The fifth terminal may be the same as or different from the first terminal.

After acquiring the fourth scale indicator, the image labeling apparatus executes the following operations in a process of executing 903.

In step 7, a third difference is obtained according to a difference between the first position and a fourth position, and a fourth difference is obtained according to a difference between a third position and a fifth position.

In some possible implementation modes, the position of the at least one person point obtained by the training apparatus by executing step 902 or step 6 includes the fourth position and the fifth position. Herein, the fourth position is a position of a person point of the first person, and the fifth position is a position of a person point of the second person.

The first position is a labeled person point tag of the first person. The third position is a labeled person point tag of the second person. The fourth position is the person point tag of the first person obtained by processing the image to be labeled by using the network to be trained. The fifth position is the person point tag of the second person obtained by processing the image to be labeled using the network to be trained.

The image labeling apparatus may obtain the third difference according to the difference between the first position and the fourth position, and may obtain the fourth difference according to the difference between the third position and the fifth position.

Optionally, the first position and the fourth position may be substituted into the binary cross entropy loss function to obtain the third difference, and the third position and the fifth position may be substituted into the binary cross entropy loss function to obtain the fourth difference.

There is made such a hypothesis that the difference between the first position and the fourth position is d₁, the third difference is d₂, the difference between the third position and the fifth position is d₃, and the fourth difference is d₄.

In a possible implementation mode, d₁, d₂, d₃, and d₄ satisfy formula (4).

$$\{ \begin{matrix}{d}_{2} = u \times {d}_{1} \\ {d}_{4} = u \times {d}_{3}\end{matrix} . \qquad Formula ( 4 )$$

u is a positive number. Optionally, u=1.

In another possible implementation mode, d₁, d₂, d₃, and d₄ satisfy formula (5).

$$\{ \begin{matrix}{d}_{2} = u \times {d}_{1} + r \\ {d}_{4} = u \times {d}_{3} + r\end{matrix} . \qquad Formula ( 5 )$$

u is a positive number, and r is a real number. Optionally, u=1, and r=0.

In another possible implementation mode, d₁, d₂, d₃, and d₄ satisfy formula (6).

$$\{ \begin{matrix}{i}_{2} = q \times \sqrt{u \times {d}_{1} + r} \\ {i}_{3} = q \times \sqrt{u \times {d}_{3} + r}\end{matrix} . \qquad Formula ( 6 )$$

u is a positive number, and r is a real number. Optionally, q=1, and m=0.

In step 8, a first weight of the third difference and a second weight of the fourth difference are obtained according to the first scale indicator and the fourth scale indicator.

In the image to be labeled, an area of a close person region is larger than an area of a distant person region, and the number of person points in the close person region is larger than the number of person points in the distant person region. Therefore, if a network obtained by training the network to be trained is a trained network, the detection accuracy of the trained network for a close person is high (namely the accuracy of a position of a close person point is higher than the accuracy of a position of a distant person point).

For improving the detection accuracy of the trained network for a distant person, the training apparatus determines a weight of a difference corresponding to a person point according to a scale indicator of the person point to make a weight of a difference corresponding to a close person point less than a weight of a difference corresponding to a distant person point.

In a possible implementation mode, the first weight is greater than the second weight under the condition that the first scale indicator is less than the fourth scale indicator. The first weight is less than the second weight under the condition that the first scale indicator is greater than the fourth scale indicator. The first weight is equal to the second weight under the condition that the first scale indicator is equal to the fourth scale indicator.

As an optional possible implementation mode, the magnitude of the weight is negatively correlated with the scale indicator of the person point. Taking the first weight and the first scale indicator as an example, if the first weight is w₁, the first scale indicator is i₁, and a maximum pixel value in the scale indicator diagram is iₘₐₓ, w₁, i₁, and iₘₐₓ satisfy formula (7).

$${w}_{1} = 1 + log \frac{{i}_{max}}{{i}_{1}} . \qquad Formula ( 7 )$$

In step 9, weighted summation is performed on the third difference and the fourth difference according to the first weight and the second weight to obtain the first difference.

There is made such a hypothesis that the first weight is w₁, the second weight is w₂, the third difference is d₂, the fourth difference is d₄, and the first difference is d₅.

In a possible implementation mode, w₁, w₂, d₂, d₄, and d₅ satisfy formula (8).

d₅=w₁×d₂+w₂×d₄+v Formula (8).

v is a real number. Optionally, v=0.

In another possible implementation mode, w₁, w₂, d₂, d₄, and d₅ satisfy formula (9).

d₅=f×(w₁×d₂+w₂×d₄+v) Formula (9).

v is a real number, and f is a positive number. Optionally, v=0, and f=1.

In another possible implementation mode, w₁, w₂, d₂, d₄, and d₅ satisfy formula (10).

d₅=\sqrt{f×(w₁×d₂+w₂×d₄+v)} Formula (10).

v is a real number, and f is a positive number. Optionally, v=0, and f=1.

In step 904, a second difference is obtained according to a difference between a labeled person box tag and the position of the at least one person box.

Optionally, the labeled person box tag and the position of the at least one person box may be substituted into a binary cross entropy loss function to obtain the second difference.

For example, the labeled person box tag includes a position of person box a and a position of person box b. The at least one person box includes a position of person box c and a position of person box d. Both person box a and person box c are person boxes of the first person, and both person box b and person box d are person boxes of the second person. The position of person box a and the position of person box c are substituted into the binary cross entropy loss function to obtain difference A. The position of person box b and the position of person box d are substituted into the binary cross entropy loss function to obtain difference B. Both difference A and difference B are first differences.

In step 905, a loss of the network to be trained is obtained according to the first difference and the second difference.

There is made such a hypothesis that the first difference is d₅, the second difference is d_{b}, and the loss of the network to be trained is L.

In a possible implementation mode, d₅, d₆, and L satisfy formula (11).

L=s×(d₅+d₆) Formula (11).

s is a positive number. Optionally, s=1.

In another possible implementation mode, d₅, d_{b}, and L satisfy formula (12).

L=s×(d₅+d₆)+n Formula (12).

s is a positive number, and n is a real number. Optionally, s=1, and n=0.

In another possible implementation mode, d₅, d₆, and L satisfy formula (13).

L=\sqrt{s×(d₅+d₆)+n} Formula (13).

s is a positive number, and n is a real number. Optionally, s=1, and n=0.

In step 906, a parameter of the network to be trained is updated based on the loss to obtain a crowd positioning network.

Optionally, the image labeling apparatus may update the parameter of the network to be trained in a back gradient propagation manner based on the loss of the network to be trained to obtain the crowd positioning network.

An image including persons may be processed based on the crowd positioning network to obtain a person point of each person and a person box of each person in the image.

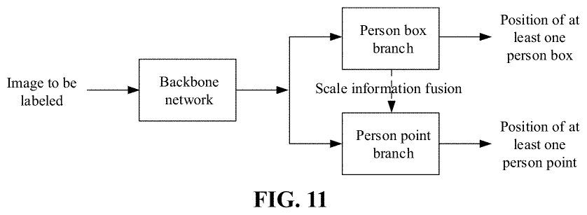

As an optional implementation mode, references are made to FIG. 11. FIG. 11 is a structure diagram of a crowd positioning network according to embodiments of the disclosure.

The image to be labeled may be processed by using the crowd positioning network to obtain a position of a person point of each person and a position of a person box of each person in the image to be labeled. A position of a person may be determined according to a position of a person point of the person and a position of a person box of the person.

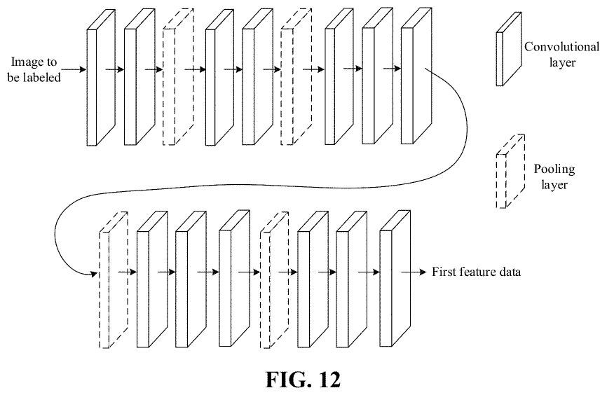

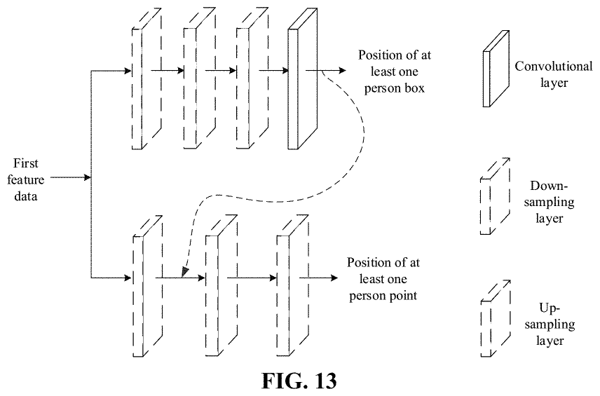

As shown in FIG. 11, the crowd positioning network may include a backbone network, a person box branch, and a person point branch. Scale information fusion may be performed on the person box branch and the person point branch. FIG. 12 is a structure diagram of the backbone network. The backbone network includes totally 13 convolutional layers and 4 pooling layers. FIG. 13 is a structure diagram of the person box branch and the person point branch. The person box branch includes totally 3 down-sampling layers and 1 convolutional layer. The person point branch includes totally 3 up-sampling layers.

The image to be labeled may be processed through the backbone network to obtain the first feature data. An implementation mode of this processing process may refer to the implementation mode of “performing feature extraction processing on the image to be labeled using the neural network to be trained to obtain the first feature data”. The first feature data may be processed through the person box branch to obtain the position of the at least one person box. This processing process may refer to step 1 and step 2. The first feature data may be processed through the person point branch to obtain the position of the at least one person point. This processing process may refer to step 3, step 4, and step 5. Herein, “scale information fusion” shown in FIG. 11 is implemented in step 4.

As an optional implementation mode, an image may be processed by using the crowd positioning network obtained based on the technical solution provided in the embodiment of the disclosure to obtain a position of a person point and a position of a person box and further determine a position of a person in the image according to the position of the person point and the position of the person box.

It should be understood that an execution body of processing the image using the crowd positioning network may be the image labeling apparatus, or may be the training apparatus, or may be an apparatus different from the image labeling apparatus and the training apparatus. For ease of expression, the execution body of processing the image using the crowd positioning network is called an apparatus for image processing hereinafter. Optionally, the apparatus for image processing may be any one of a mobile phone, a computer, a tablet computer, a server, and a processor.

In a possible implementation mode, the apparatus for image processing acquires an image to be processed, and processes the image to be processed by using the crowd positioning network to obtain a position of a person point of a third person and a position of a person box of the third person. Herein, the third person is a person in the image to be processed. Furthermore, a position of the third person in the image to be processed may be determined according to the position of the person point of the third person. Alternatively, the position of the third person in the image to be processed may be determined according to the position of the person box of the third person. Alternatively, the position of the third person in the image to be processed may be determined according to the position of the person point of the third person and the position of the person box of the third person.

For example, the position of the person point of the third person is (9, 10), a shape of the person box of the third person is a rectangle, and the position of the person box of the third person includes coordinates (6, 8) and (12, 14) of a pair of diagonal vertexes of the rectangle. When the position of the person point of the third person is determined as the position of the third person in the image to be processed, it is determined that the position of the third person in the image to be processed is (9, 10). When the position of the person box of the third person is determined as the position of the third person in the image to be processed, a pixel region in the rectangular person box in the image to be processed is determined as a pixel region covered by the third person. Herein, coordinates of four vertexes of the rectangular person box are (6, 8), (6, 14), (12, 14), and (12, 8) respectively.

As an optional implementation mode, in the embodiments of the disclosure, the person point (including the second person point, the at least one person point in 902, and the person point of the third person) may be a head point, and the person box (including the at least one person box in 902 and the person box of the third person) may be a head box. Both a pixel region covered by the head point and a pixel region in the head box are the head region.

Based on the technical solution provided in the embodiments of the disclosure, the embodiments of the disclosure also provide a possible application scene.

The apparatus for image labeling trains a detection convolutional neural network (which may be any convolutional neural network) by using a face detection dataset, and obtains a face detection network. Each image in the face detection dataset contains labeling information, and the labeling information includes a position of a face box. Optionally, the face dataset is Wider Face.

The apparatus for image labeling processes a crowd dataset by using the face detection network to obtain a face detection result of each image in the crowd dataset and a confidence of each face detection result. Each image in the crowd dataset includes at least one head, and each image includes at least one head point tag. Optionally, a face detection result of which the confidence is greater than a third threshold is determined as a first intermediate result. Optionally, the third threshold is 0.7.

The apparatus for image labeling acquires a length (for example, 20 centimeters) of a face in the real world, and obtains a scale indicator diagram of each image in the crowd dataset according to the length and the first intermediate result.

The apparatus for image labeling may label each image in the crowd dataset with a head point tag and a head box tag based on the technical solution provided in the embodiments of the disclosure, the crowd dataset, and the scale indicator diagram of each image in the crowd dataset to obtain a labeled crowd dataset.

The apparatus for image labeling trains a second detection network (a network structure may refer to the network structure of the crowd positioning network) by using the labeled crowd dataset to obtain a positioning network. The positioning network may be configured to detect a position of a head point of each head and a position of a head box of each head in an image.

It can be understood by those skilled in the art that, in the method of the specific implementation modes, the writing sequence of each step does not mean a strict execution sequence and is not intended to form any limit to the implementation process and an execution sequence of each step should be determined by functions and probable internal logic thereof.

The method of the embodiments of the disclosure is described above in detail, and an apparatus of the embodiments of the disclosure will be provided below.

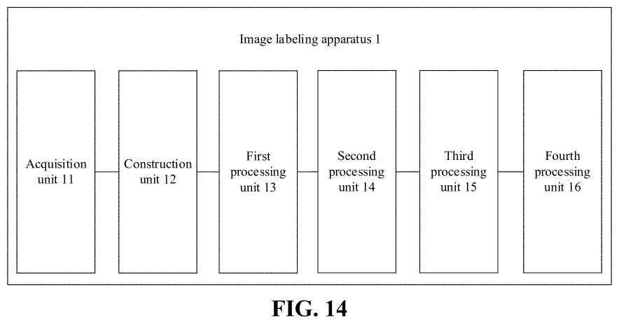

Referring to FIG. 14 which is a structure diagram of an apparatus for image labeling according to embodiments of the disclosure, the apparatus for image labeling 1 includes an acquisition unit 11, a construction unit 12, a first processing unit 13, a second processing unit 14, a third processing unit 15, and a fourth processing unit 16.

The acquisition unit 11 is configured to acquire an image to be labeled and a first scale indicator. The image to be labeled contains a person point tag of a first person. The person point tag of the first person includes a first position of a first person point. The first scale indicator represents a mapping between a first size and a second size. The first size is a size of a first reference object at the first position, and the second size is a size of the first reference object in a real world.

The construction unit 12 is configured to construct a pixel neighborhood based on the first person point under the condition that the first scale indicator is more than or equal to a first threshold, the pixel neighborhood including a first pixel different from the first person point.

The first processing unit 13 is configured to determine a position of the first pixel as the person point tag of the first person.

In combination with any implementation mode of the disclosure, the acquisition unit 11 is further configured to acquire a first length, the first length being a length of the first person in the real world.

The apparatus further includes the second processing unit. The second processing unit 14 is configured to: obtain a position of at least one person box of the first person according to the first position, the first scale indicator, and the first length; and determine the position of the at least one person box as the person box tag of the first person.

In combination with any implementation mode of the disclosure, the position of the at least one person box includes a second position.

The second processing unit 14 is configured to: determine a product of the first scale indicator and the first length to obtain a second length of the first person in the image to be labeled; and determine a position of a first person box as the second position according to the first position and the second length, a center of the first person box being the first person point, and a maximum length of the first person box in a y-axis direction being not less than the second length.

In combination with any implementation mode of the disclosure, a shape of the first person box is a rectangle.

The second processing unit 14 is configured to: determine a coordinate of a diagonal vertex of the first person box according to the first position and the second length. The diagonal vertex includes a first vertex and a second vertex. Both the first vertex and the second vertex are points on a first line segment. The first line segment is a diagonal of the first person box.

In combination with any implementation mode of the disclosure, the shape of the first person box is a square, and a coordinate of the first position under a pixel coordinate system of the image to be labeled is (p, q).

The second processing unit 14 is configured to: determine a difference between p and a third length to obtain a first abscissa, determine a difference between q and the third length to obtain a first ordinate, determine a sum of p and the third length to obtain a second abscissa, and determine a sum of q and the third length to obtain a second ordinate, the third length being a half of the second length; and determine the first abscissa as an abscissa of the first vertex, determine the first ordinate as an ordinate of the first vertex, determine the second abscissa as an abscissa of the second vertex, and determine the second ordinate as an ordinate of the second vertex.

In combination with any implementation mode of the disclosure, the acquisition unit 11 is configured to: perform object detection processing on the image to be labeled to obtain a first object box and a second object box; obtain the third length according to a length of the first object box in the y-axis direction, and obtain a fourth length according to a length of the second object box in the y-axis direction, a y axis being an ordinate axis of the pixel coordinate system of the image to be labeled; obtain a second scale indicator according to the third length and a fifth length of a first object in the real world, and obtain a third scale indicator according to the fourth length and a sixth length of a second object in the real world, the first object being a detection target in the first object box, the second object being a detection target in the second object box, the second scale indicator representing a mapping between a third size and a fourth size, the third size being a size of a second reference object at a second-scale position, the fourth size being a size of the second reference object in the real world, the second-scale position being a position determined in the image to be labeled according to a position of the first object box, the third scale indicator representing a mapping between a fifth size and a sixth size, the fifth size being a size of a third reference object at a third-scale position, the sixth size being a size of the third reference object in the real world, and the third-scale position being a position determined in the image to be labeled according to a position of the second object box; perform curve fitting processing on the second scale indicator and the third scale indicator to obtain a scale indicator diagram of the image to be labeled, a first pixel value in the scale indicator diagram representing a mapping between a seventh size and an eighth size, the seventh size being a size of a fourth reference object at a fourth-scale position, the eighth size being a size of the fourth reference object in the real world, the first pixel value being a pixel value of a second pixel, the fourth-scale position being a position of a third pixel in the image to be labeled, and a position of the second pixel in the scale indicator diagram being the same as the position of the third pixel in the image to be labeled; and obtain the first scale indicator according to the scale indicator diagram and the first position.

In combination with any implementation mode of the disclosure, the person point tag of the first person is a labeled person point tag, and the person box tag of the first person is a labeled person box tag. The acquisition unit 11 is further configured to acquire a network to be trained.

The apparatus further includes a third processing unit 15. The third processing unit 15 is configured to: process the image to be labeled using the network to be trained to obtain a position of at least one person point and the position of the at least one person box; obtain a first difference according to a difference between the labeled person point tag and the position of the at least one person point; obtain a second difference according to a difference between the labeled person box tag and the position of the at least one person box; obtain a loss of the network to be trained according to the first difference and the second difference; and update a parameter of the network to be trained based on the loss to obtain a crowd positioning network.

In combination with any implementation mode of the disclosure, a person point tag of a second person is also a labeled person point tag. The person point tag of the second person includes a third position of a second person point. The position of the at least one person point includes a fourth position and a fifth position. The fourth position is a position of a person point of the first person, and the fifth position is a position of a person point of the second person.

The acquisition unit 11 is further configured to, before the first difference is obtained according to the difference between the labeled person point tag and the position of the at least one person point, acquire a fourth scale indicator. The fourth scale indicator represents a mapping between a ninth size and a tenth size. The ninth size is a size of a fifth reference object at the third position, and the tenth size is a size of the fifth reference object in the real world.

The third processing unit 15 is configured to: obtain a third difference according to a difference between the first position and the fourth position, and obtain a fourth difference according to a difference between the third position and the fifth position; obtain a first weight of the third difference and a second weight of the fourth difference according to the first scale indicator and the fourth scale indicator, the first weight being greater than the second weight under the condition that the first scale indicator is less than the fourth scale indicator, the first weight being less than the second weight under the condition that the first scale indicator is greater than the fourth scale indicator, and the first weight being equal to the second weight under the condition that the first scale indicator is equal to the fourth scale indicator; and perform weighted summation on the third difference and the fourth difference according to the first weight and the second weight to obtain the first difference.

In combination with any implementation mode of the disclosure, the acquisition unit 11 is configured to: obtain the fourth scale indicator according to the scale indicator diagram and the third position.

In combination with any implementation mode of the disclosure, the third processing unit 15 is configured to: perform feature extraction processing on the image to be labeled to obtain first feature data; perform down-sampling processing on the first feature data to obtain the position of the at least one person box; and perform up-sampling processing on the first feature data to obtain the position of the at least one person point.

In combination with any implementation mode of the disclosure, the third processing unit 15 is configured to: perform down-sampling processing on the first feature data to obtain second feature data; and perform convolution processing on the second feature data to obtain the position of the at least one person box.

The operation that up-sampling processing is performed on the first feature data to obtain the position of the at least one person point includes the following operations.

Up-sampling processing is performed on the first feature data to obtain third feature data.

Fusion processing is performed on the second feature data and the third feature data to obtain fourth feature data.

Up-sampling processing is performed on the fourth feature data to obtain the position of the at least one person point.

In combination with any implementation mode of the disclosure, the acquisition unit 11 is further configured to acquire an image to be processed.

The apparatus further includes a fourth processing unit 16. The fourth processing unit 16 is configured to: process the image to be processed using the crowd positioning network to obtain a position of a person point of a third person and a position of a person box of the third person, the third person being a person in the image to be processed.

In some possible implementation modes, whether there is any unlabeled pixel in a person region is determined according to a labeled person point and a scale indicator of the labeled person point. Under the condition that there is an unlabeled pixel in the person region, a pixel neighborhood is constructed based on the labeled person point, and a position of a pixel, except the labeled person point, in the pixel neighborhood is determined as a tag of a person corresponding to the person region. Therefore, the labeling accuracy is improved.

In some embodiments, functions or modules of the apparatus provided in the embodiments of the disclosure may be configured to execute the method described in the method embodiments, and specific implementation thereof may refer to the descriptions about the method embodiments and, for simplicity, will not be elaborated herein.

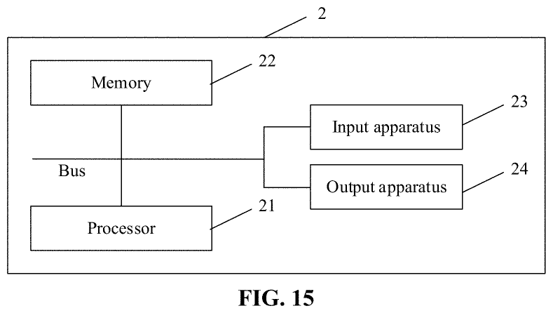

FIG. 15 is a hardware structure diagram of an apparatus for image labeling according to embodiments of the disclosure. The apparatus for image labeling 2 includes a processor 21, a memory 22, an input apparatus 23, and an output apparatus 24. The processor 21, the memory 22, the input apparatus 23, and the output apparatus 24 are coupled through a connector. The connector includes various interfaces, transmission lines, buses, or the like. No limits are made thereto in the embodiments of the disclosure. It is to be understood that, in each embodiment of the disclosure, coupling refers to interconnection implemented in a specific manner, including direct connection or direct connection through another device, for example, connection through various interfaces, transmission lines, and buses.

The processor 21 may be one or more Graphics Processing Units (GPUs). Under the condition that the processor 21 is one GPU, the GPU may be a single-core GPU, or may be a multi-core GPU. Optionally, the processor 21 may be a processor set consisting of multiple GPUs, and multiple processors are coupled with one another through one or more buses. Optionally, the processor may also be a processor of another type, etc. No limits are made in the embodiment of the disclosure.

The memory 22 may be configured to store computer program instructions and various computer program codes including a program code configured to execute the technical solution provided in the embodiment of the disclosure. Optionally, the memory 22 includes, but not limited to, a Random Access Memory (RAM), a Read-Only Memory (ROM), an Erasable Programmable ROM (EPROM), or a Compact Disc ROM (CD-ROM). The memory 22 is configured to store related instructions and data.

The input apparatus 23 is configured to input data and/or signals, and the output apparatus 24 is configured to output data and/or signals. The input apparatus 23 and the output apparatus 24 may be independent devices, or may be integrated.

It can be understood that, in some possible implementation modes, the memory 22 may not only be configured to store related instructions but also be configured to store related data. For example, the memory 22 may be configured to store an image to be labeled acquired by the input apparatus 23. Alternatively, the memory 22 may also be configured to store a position of a second pixel obtained by the processor 21, etc. Data stored in the memory is not limited in the embodiment of the disclosure.

It can be understood that FIG. 15 only shows a simplified design of the image labeling apparatus. In practical applications, the image labeling apparatus may further include other required components, including, but not limited to, any number of input/output apparatuses, processors, memories, etc. All image labeling apparatuses capable of implementing the embodiments of the disclosure fall within the scope of protection of the disclosure.

Those of ordinary skill in the art may realize that the units and algorithm steps of each example described in combination with the embodiments disclosed in the disclosure may be implemented by electronic hardware or a combination of computer software and the electronic hardware. Whether these functions are executed by hardware or software depends on specific applications and design constraints of the technical solutions. Professionals may realize the described functions for each specific application by use of different methods, but such realization shall fall within the scope of the disclosure.

Those skilled in the art may clearly learn about that working processes of the system, apparatus, and unit described above may refer to the corresponding processes in the method embodiment and will not be elaborated herein for ease and briefness of description. Those skilled in the art may also clearly know that the embodiments of the disclosure are described with different focuses. For ease and briefness of description, elaborations about the same or similar parts may be omitted in different embodiments, and thus parts that are not described or detailed in an embodiment may refer to records in the other embodiments.

In some embodiments provided by the disclosure, it is to be understood that the disclosed system, apparatus, and method may be implemented in another manner. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the apparatus or the units, and may be electrical and mechanical or adopt other forms.

The units described as separate parts may or may not be physically separated, and parts displayed as units may or may not be physical units, namely they may be located in the same place, or may be distributed to multiple network units. Part or all of the units may be selected to achieve the purposes of the solutions of the embodiments according to a practical requirement.

In addition, each function unit in each embodiment of the disclosure may be integrated into a processing unit, or each unit may physically exist independently, or two or more than two units may also be integrated into a unit.

The embodiments may be implemented completely or partially through software, hardware, firmware, or any combination thereof. During implementation with the software, the embodiments may be implemented completely or partially in form of a computer program product. The computer program product includes one or more computer instructions. When the computer program instruction is loaded and executed on a computer, the flows or functions according to the embodiments of the disclosure are completely or partially generated. The computer may be a general purpose computer, a special purpose computer, a computer network, or another programmable device. The computer instruction may be stored in a computer-readable storage medium or transmitted through the computer-readable storage medium. The computer instruction may be transmitted from one website, computer, server, or data center to another website, computer, server, or data center in a wired (for example, a coaxial cable, an optical fiber and a Digital Subscriber Line (DSL)) or wireless (for example, infrared, radio and microwave) manner. The computer-readable storage medium may be any available medium accessible for the computer or a data storage device, such as a server and a data center, including one or more integrated available media. The available medium may be a magnetic medium (for example, a floppy disk, a hard disk, and a magnetic tape), an optical medium (for example, a Digital Versatile Disc (DVD)), a semiconductor medium (for example, a Solid State Disk (SSD)), or the like.

It can be understood by those of ordinary skill in the art that all or part of the flows in the method of the abovementioned embodiments may be completed by instructing related hardware through a computer program. The program may be stored in a computer-readable storage medium. When the program is executed, the flows of each method embodiment may be included. The storage medium includes: various media capable of storing program codes such as a ROM, a RAM, a magnetic disk, or an optical disk.

What is claimed is:

1. A method for image labeling, comprising:
acquiring an image to be labeled and a first scale indicator, wherein the image to be labeled contains a person point tag of a first person, the person point tag of the first person comprises a first position of a first person point, the first scale indicator represents a mapping between a first size and a second size, the first size is a size of a first reference object at the first position, and the second size is a size of the first reference object in a real world;
constructing a pixel neighborhood based on the first person point under a condition that the first scale indicator is more than or equal to a first threshold, the pixel neighborhood comprising a first pixel different from the first person point; and
determining a position of the first pixel as the person point tag of the first person.

2. The method of claim 1, further comprising:
acquiring a first length, the first length being a length of the first person in the real world;
obtaining a position of at least one person box of the first person according to the first position, the first scale indicator, and the first length; and
determining the position of the at least one person box as a person box tag of the first person.

3. The method of claim 2, wherein the position of the at least one person box comprises a second position; and
obtaining the position of the at least one person box of the first person according to the first position, the first scale indicator, and the first length comprises:
determining a product of the first scale indicator and the first length to obtain a second length of the first person in the image to be labeled, and
determining a position of a first person box as the second position according to the first position and the second length, a center of the first person box being the first person point, and a maximum length of the first person box in a y-axis direction being not less than the second length.

4. The method of claim 3, wherein a shape of the first person box is a rectangle; and
determining the position of the first person box according to the first position and the second length comprises:
determining a coordinate of a diagonal vertex of the first person box according to the first position and the second length, wherein the diagonal vertex comprises a first vertex and a second vertex, both the first vertex and the second vertex are points on a first line segment, and the first line segment is a diagonal of the first person box.

5. The method of claim 4, wherein a shape of the first person box is a square, and a coordinate of the first position under a pixel coordinate system of the image to be labeled is (p, q), wherein
determining the coordinate of the diagonal vertex of the first person box according to the first position and the second length comprises:
determining a difference between p and a third length to obtain a first abscissa, determining a difference between q and the third length to obtain a first ordinate, determining a sum of p and the third length to obtain a second abscissa, and determining a sum of q and the third length to obtain a second ordinate, the third length being a half of the second length; and
determining the first abscissa as an abscissa of the first vertex, determining the first ordinate as an ordinate of the first vertex, determining the second abscissa as an abscissa of the second vertex, and determining the second ordinate as an ordinate of the second vertex.

6. The method of claim 2, wherein acquiring the first scale indicator comprises:
performing object detection processing on the image to be labeled to obtain a first object box and a second object box;
obtaining the third length according to a length of the first object box in the y-axis direction, and obtaining a fourth length according to a length of the second object box in the y-axis direction, a y axis being an ordinate axis of the pixel coordinate system of the image to be labeled;
obtaining a second scale indicator according to the third length and a fifth length of a first object in the real world, and obtaining a third scale indicator according to the fourth length and a sixth length of a second object in the real world, wherein the first object is a detection target in the first object box, the second object is a detection target in the second object box, the second scale indicator represents a mapping between a third size and a fourth size, the third size is a size of a second reference object at a second-scale position, the fourth size is a size of the second reference object in the real world, the second-scale position is a position determined in the image to be labeled according to a position of the first object box, the third scale indicator represents a mapping between a fifth size and a sixth size, the fifth size is a size of a third reference object at a third-scale position, the sixth size is a size of the third reference object in the real world, and the third-scale position is a position determined in the image to be labeled according to a position of the second object box;
performing curve fitting processing on the second scale indicator and the third scale indicator to obtain a scale indicator diagram of the image to be labeled, wherein a first pixel value in the scale indicator diagram represents a mapping between a seventh size and an eighth size, the seventh size is a size of a fourth reference object at a fourth-scale position, the eighth size is a size of the fourth reference object in the real world, the first pixel value is a pixel value of a second pixel, the fourth-scale position is a position of a third pixel in the image to be labeled, and a position of the second pixel in the scale indicator diagram is the same as the position of the third pixel in the image to be labeled; and
obtaining the first scale indicator according to the scale indicator diagram and the first position.

7. The method of claim 6, wherein a labeled person point tag comprises the person point tag of the first person, and the person box tag of the first person is a labeled person box tag; and the method further comprises:
acquiring a network to be trained,
processing the image to be labeled using the network to be trained to obtain a position of at least one person point and the position of the at least one person box,
obtaining a first difference according to a difference between the labeled person point tag and the position of the at least one person point,
obtaining a second difference according to a difference between the labeled person box tag and the position of the at least one person box,
obtaining a loss of the network to be trained according to the first difference and the second difference, and
updating a parameter of the network to be trained based on the loss to obtain a crowd positioning network.

8. The method of claim 7, wherein the labeled person point tag further comprises a person point tag of a second person, the person point tag of the second person comprises a third position of a second person point, the position of the at least one person point comprises a fourth position and a fifth position, the fourth position is a position of a person point of the first person, and the fifth position is a position of a person point of the second person; and
before obtaining the first difference according to the difference between the labeled person point tag and the position of the at least one person point, the method further comprises:
acquiring a fourth scale indicator, wherein the fourth scale indicator represents a mapping between a ninth size and a tenth size, the ninth size is a size of a fifth reference object at the third position, and the tenth size is a size of the fifth reference object in the real world, wherein
obtaining the first difference according to the difference between the labeled person point tag and the position of the at least one person point comprises:
obtaining a third difference according to a difference between the first position and the fourth position, and obtaining a fourth difference according to a difference between the third position and the fifth position;
obtaining a first weight of the third difference and a second weight of the fourth difference according to the first scale indicator and the fourth scale indicator, wherein the first weight is greater than the second weight under a condition that the first scale indicator is less than the fourth scale indicator, the first weight is less than the second weight under a condition that the first scale indicator is greater than the fourth scale indicator, and the first weight is equal to the second weight under a condition that the first scale indicator is equal to the fourth scale indicator; and
performing weighted summation on the third difference and the fourth difference according to the first weight and the second weight to obtain the first difference.

9. The method of claim 8, wherein acquiring the fourth scale indicator comprises:
obtaining the fourth scale indicator according to the scale indicator diagram and the third position.

10. The method of claim 7, wherein processing the image to be labeled using the network to be trained to obtain the position of the at least one person point and the position of the at least one person box comprises:
performing feature extraction processing on the image to be labeled to obtain first feature data;
performing down-sampling processing on the first feature data to obtain the position of the at least one person box; and
performing up-sampling processing on the first feature data to obtain the position of the at least one person point.

11. The method of claim 10, wherein performing down-sampling processing on the first feature data to obtain the position of the at least one person box comprises:
performing down-sampling processing on the first feature data to obtain second feature data, and
performing convolution processing on the second feature data to obtain the position of the at least one person box; and
performing up-sampling processing on the first feature data to obtain the position of the at least one person point comprises:
performing up-sampling processing on the first feature data to obtain third feature data,
performing fusion processing on the second feature data and the third feature data to obtain fourth feature data, and
performing up-sampling processing on the fourth feature data to obtain the position of the at least one person point.

12. The method of claim 7, further comprising:
acquiring an image to be processed; and
processing the image to be processed using the crowd positioning network to obtain a position of a person point of a third person and a position of a person box of the third person, the third person being a person in the image to be processed.

13. An electronic device, comprising a processor and a memory, wherein the memory is configured to store computer program codes; the computer program codes comprise computer instructions; and when the processor executes the computer instructions, the processor is configured to:
acquire an image to be labeled and a first scale indicator, wherein the image to be labeled contains a person point tag of a first person, the person point tag of the first person comprises a first position of a first person point, the first scale indicator represents a mapping between a first size and a second size, the first size is a size of a first reference object at the first position, and the second size is a size of the first reference object in a real world;
construct a pixel neighborhood based on the first person point under a condition that the first scale indicator is more than or equal to a first threshold, the pixel neighborhood comprising a first pixel different from the first person point; and
determine a position of the first pixel as the person point tag of the first person.

14. The electronic device of claim 13, wherein the processor is further configured to:
acquire a first length, the first length being a length of the first person in the real world;
obtain a position of at least one person box of the first person according to the first position, the first scale indicator, and the first length; and
determine the position of the at least one person box as a person box tag of the first person.

15. The electronic device of claim 14, wherein the position of the at least one person box comprises a second position; and
the processor is further configured to:
determine a product of the first scale indicator and the first length to obtain a second length of the first person in the image to be labeled, and
determine a position of a first person box as the second position according to the first position and the second length, a center of the first person box being the first person point, and a maximum length of the first person box in a y-axis direction being not less than the second length.

16. The electronic device of claim 15, wherein a shape of the first person box is a rectangle; and
the processor is further configured to:
determine a coordinate of a diagonal vertex of the first person box according to the first position and the second length, wherein the diagonal vertex comprises a first vertex and a second vertex, both the first vertex and the second vertex are points on a first line segment, and the first line segment is a diagonal of the first person box.

17. The electronic device of claim 16, wherein a shape of the first person box is a square, and a coordinate of the first position under a pixel coordinate system of the image to be labeled is (p, q), wherein
the processor is further configured to:
determine a difference between p and a third length to obtain a first abscissa, determining a difference between q and the third length to obtain a first ordinate, determining a sum of p and the third length to obtain a second abscissa, and determining a sum of q and the third length to obtain a second ordinate, the third length being a half of the second length; and
determine the first abscissa as an abscissa of the first vertex, determining the first ordinate as an ordinate of the first vertex, determining the second abscissa as an abscissa of the second vertex, and determining the second ordinate as an ordinate of the second vertex.

18. The electronic device of claim 14, wherein the processor is further configured to:
perform object detection processing on the image to be labeled to obtain a first object box and a second object box;
obtain the third length according to a length of the first object box in the y-axis direction, and obtaining a fourth length according to a length of the second object box in the y-axis direction, a y axis being an ordinate axis of the pixel coordinate system of the image to be labeled;
obtain a second scale indicator according to the third length and a fifth length of a first object in the real world, and obtaining a third scale indicator according to the fourth length and a sixth length of a second object in the real world, wherein the first object is a detection target in the first object box, the second object is a detection target in the second object box, the second scale indicator represents a mapping between a third size and a fourth size, the third size is a size of a second reference object at a second-scale position, the fourth size is a size of the second reference object in the real world, the second-scale position is a position determined in the image to be labeled according to a position of the first object box, the third scale indicator represents a mapping between a fifth size and a sixth size, the fifth size is a size of a third reference object at a third-scale position, the sixth size is a size of the third reference object in the real world, and the third-scale position is a position determined in the image to be labeled according to a position of the second object box;
perform curve fitting processing on the second scale indicator and the third scale indicator to obtain a scale indicator diagram of the image to be labeled, wherein a first pixel value in the scale indicator diagram represents a mapping between a seventh size and an eighth size, the seventh size is a size of a fourth reference object at a fourth-scale position, the eighth size is a size of the fourth reference object in the real world, the first pixel value is a pixel value of a second pixel, the fourth-scale position is a position of a third pixel in the image to be labeled, and a position of the second pixel in the scale indicator diagram is the same as the position of the third pixel in the image to be labeled; and
obtain the first scale indicator according to the scale indicator diagram and the first position.

19. The electronic device of claim 18, wherein a labeled person point tag comprises the person point tag of the first person, and the person box tag of the first person is a labeled person box tag; and the processor is further configured to:
acquire a network to be trained,
process the image to be labeled using the network to be trained to obtain a position of at least one person point and the position of the at least one person box,
obtain a first difference according to a difference between the labeled person point tag and the position of the at least one person point,
obtain a second difference according to a difference between the labeled person box tag and the position of the at least one person box,
obtain a loss of the network to be trained according to the first difference and the second difference, and
update a parameter of the network to be trained based on the loss to obtain a crowd positioning network.

20. A non-transitory computer-readable storage medium, in which a computer program is stored, wherein the computer program comprises program instructions, and the program instructions are executed by a processor to enable the processor to perform:
acquiring an image to be labeled and a first scale indicator, wherein the image to be labeled contains a person point tag of a first person, the person point tag of the first person comprises a first position of a first person point, the first scale indicator represents a mapping between a first size and a second size, the first size is a size of a first reference object at the first position, and the second size is a size of the first reference object in a real world;
constructing a pixel neighborhood based on the first person point under a condition that the first scale indicator is more than or equal to a first threshold, the pixel neighborhood comprising a first pixel different from the first person point; and
determining a position of the first pixel as the person point tag of the first person.
